(19) United States
(12) Patent Application Publication
(10) Pub. No.: US 2022/0034442 A1
(43) Pub. Date: Feb. 3, 2022

(54) COUPLER HAVING PROTECTIVE BUMPERS AND BANDS

(71) Applicants: Daniel C. Swanson, Chicago, IL (US); Karolina Stus, Chicago, IL (US); Andy Pietraszek, Chicago, IL (US)

(72) Inventors: Daniel C. Swanson, Chicago, IL (US); Karolina Stus, Chicago, IL (US); Andy Pietraszek, Chicago, IL (US)

(21) Appl. No.: 17/385,756

(22) Filed: Jul. 26, 2021

Related U.S. Application Data
(60) Provisional application No. 63/059,022, filed on Jul. 30, 2020.

(51) Int. Cl. F16L 57/06; F16L 21/00

(52) U.S. Cl. CPC F16L 57/06; F16L 21/002

(57) ABSTRACT

A coupler having at least one protective bumper is provided. The protective bumper is located on the exterior surface of the side of a movable sleeve of a coupler. The sleeve moves with respect to a main body of the coupler to lock or release a mating plug. A second sleeve of the coupler may also have protective bands. The protective bumpers and bands protect the coupler from damage as might otherwise occur from external forces acting upon it during use. Preferably, the diameters of the plurality of bumpers decreases the closer to the distal end of the sleeve the bumpers are located.

### REFERENCE TO RELATED APPLICATIONS

This application claims priority to U.S. Provisional Application No. 63/059,022, which is titled “COUPLER HAVING PROTECTIVE BUMPERS AND BANDS” which was filed on Jul. 30, 2020, the entire contents of which are incorporated by reference herein.

### BACKGROUND OF THE INVENTION

A coupler having at least one protective bumper is provided. The protective bumper is located on the exterior surface of the side of a movable sleeve of a coupler. The sleeve moves with respect to a main body of the coupler to lock or release a mating plug. A second sleeve of the coupler may also have protective bands. The protective bumpers and bands protect the coupler from damage as might otherwise occur from external forces acting upon it during use. Preferably, the diameters of the plurality of bumpers decreases the closer to the distal end of the sleeve the bumpers are located.

Couplers have been known in the past. For example, U.S. Pat. No. 5,337,782 to Wilcox discloses a hydraulic coupler half simple enough for use in miniature couplings. Both the relief ports and the main fluid ports are in the pintle. The relief ports are uncovered by a hyperextension of the pintle; the main fluid ports are uncovered by retraction of a sliding sleeve around the pintle. The pintle has a single annular contact point with the coupler body and clearances between the walls so that exact alignment is not necessary for connection. The nipple half is conventional.

Further, U.S. Pat. No. 6,786,516 to Cronley discloses a coupler for coupling a male end of a hose to a female end of a faucet or another hose. In the first embodiment, the female end of the coupler is mechanically locked in sealing engagement with a male end by simply translation thereof by means of wedges and an outer retaining sleeve. In a second embodiment, hydraulic pressure provides the final seal, with the female end being a spring split-ring locked and compressed by means of an outer locking sleeve, which outer locking sleeve is released by squeezing it in order to deform it. A third embodiment combines the first and second embodiments.

However, these coupler systems fail to disclose a coupler having protective bumpers and bands which are easy to use, efficient and inexpensive as is disclosed in the present application.

### SUMMARY OF THE INVENTION

A coupler having at least one protective bumper is provided. The protective bumper is located on the exterior surface of the side of a movable sleeve of a coupler. The sleeve moves with respect to a main body of the coupler to lock or release a mating plug. A second sleeve of the coupler may also have protective bands. The protective bumpers and bands protect the coupler from damage as might otherwise occur from external forces acting upon it during use. Preferably, the diameters of the plurality of bumpers decreases the closer to the distal end of the sleeve the bumpers are located.

An advantage of the present coupler system is that the present coupler system has protective bumpers for protecting the main body and sleeves of the coupler from external forces which would otherwise damage the main body and/or sleeves of the coupler.

Another advantage of the present coupler system is that the present coupler system allows, in one embodiment, for the bumpers to be replaced when damaged, therein prolonging the life of the coupler.

For a more complete understanding of the above listed features and advantages of the present coupler system reference should be made to the following detailed description of the preferred embodiments. Further, additional features and advantages of the invention are described in, and will be apparent from, the detailed description of the preferred embodiments.

### BRIEF DESCRIPTION OF THE DRAWINGS

FIG. 1 illustrates a perspective view of the main body and the first and the second sleeves of the present coupler.

FIG. 2 illustrates a side view of the present main body and first and second sleeves of the coupler with bumpers wherein a portion of the entire coupler is removed to illustrate a cut-away section.

FIG. 3 illustrates a prior art coupler and sleeves lacking the bumpers.

### DETAILED DESCRIPTION OF THE PREFERRED EMBODIMENTS

A coupler having at least one protective bumper is provided. The protective bumper is located on the exterior surface of the side of a movable sleeve of a coupler. The sleeve moves with respect to a main body of the coupler to lock or release a mating plug. A second sleeve of the coupler may also have protective bands. The protective bumpers and bands protect the coupler from damage as might otherwise occur from external forces acting upon it during use. Preferably, the diameters of the plurality of bumpers decreases the closer to the distal end of the sleeve the bumpers are located.

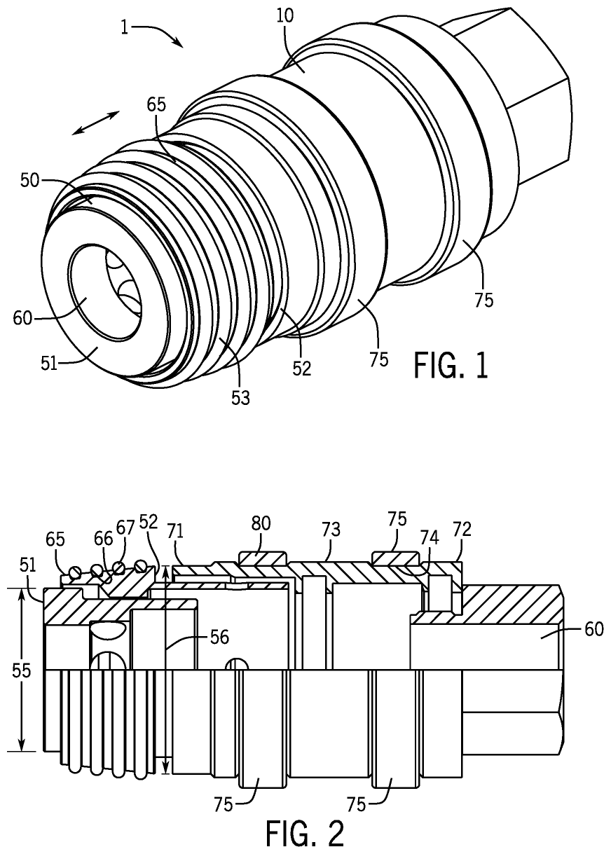

Referring first to FIG. 1, in an embodiment, a coupler 1 is provided. The coupler 1 may have a first sleeve 10, a second sleeve 50 and a stationary main body (the main body being located to the right of the first sleeve 10 in the drawings). In an embodiment, the first sleeve 10 may move with respect to the main body and may move independent of the second sleeve 50 which also moves. The first sleeve 10 may act as a protective release/locking sleeve for the coupler 1. In particular, the first sleeve 10 may lock or release the second sleeve 50 in one embodiment. Further, the first sleeve 10 may move up against the second sleeve 50 in a first position and may be removed from the second sleeve 50 in a second position.

In an embodiment, the second sleeve 50 may move with respect to the first sleeve 10 of the coupler 1. More specifically, the second sleeve 50 may move along the same axis line of the first sleeve 10 and may be surrounded by a cross-section of the first sleeve 10. The second sleeve 50 may temporarily connect to a mating plug (not shown).

The second sleeve 50 may move so that the coupler 1 may be locked onto or may be removed from a corresponding mating plug (not shown). The movement of the second sleeve 50 therein releases or locks the present coupler 1 to the corresponding mating plug. Once the coupler 1 and matting plug are attached, a fluid, generally air, may pass from one coupler through to the corresponding mating plug. Preferably, elements of the coupler 1 are largely made of a durable and non-corrosive metal.

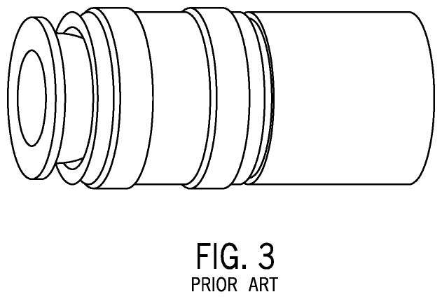

The second sleeve 50 may have a first end 51, a second end 52 and a side 53. In the preferred embodiment the side 53 of the second sleeve 50 is tapered so that the second sleeve 50 is not cylindrical. In particular, the first end 51 of the second sleeve 50 may have a diameter 55 (FIG. 2) which is less than a diameter 56 of the second end 52 of the second sleeve 50. The tapered second sleeve 50 may allow the second sleeve 50 to better engage with the mating plug. A hollow interior channel 60 may pass through not only the second sleeve 50 but also the first sleeve 10 of the coupler 1 so that the fluid (air) may pass.

The side 53 of the second sleeve 50 may have an exterior surface 65. Located on the exterior surface 65 of the side 53 of the second sleeve 50 may be at least one groove 66 which surrounds the exterior surface 65 of the second sleeve 50. The figures illustrate four grooves 66 located on the second sleeve 50; however, a greater or fewer number of grooves 66 may be utilized on the second sleeve 50 depending on the desired function of that specific coupler 1.

In an embodiment, each of the grooves 66 may receive a bumper 67 (or ‘o-ring’). The bumpers 67 are preferably made of a durable material such as a durable rubber or plastic. The bumpers 67 may be elastic having a diameter slightly less than the diameter of its corresponding groove 66 so that the bumpers 67 remain secured within the grooves 65 by at least friction and may also be elastic so that the bumpers 67 may dampen the external forces which would otherwise contact the coupler and/or sleeves themselves. In an alternative embodiment, an adhesive may be used to secure the bumpers 67 within the groove 66.

Because the exterior surface 65 of the second sleeve 50 decreases in diameter as it approaches the first end 51 of the second sleeve 50, the diameter of the bumpers 67 also correspondingly decrease in size. The bumpers 67 act to protect the second sleeve 50 from damage when an external force is applied to the second sleeve 50. More specifically, it is common for a coupler to be dropped on the ground or banged by tools or other mechanical devices during use. Either instantly or over time, these prior art couplers (See FIG. 3) may be damaged and may fail due to these external forces.

In an embodiment the first sleeve 10 of the coupler 1 may have a first end 71, a second end 72 and an exterior side 73. At least one groove 74 may be present on the first sleeve 10 of the coupler 1. The groove 74 may receive a protective band 75 in a similar manner as the bumpers 67 of the second sleeve 50. The figures illustrate two protective bands 75 on the first sleeve 10 of the coupler 1; however, a greater or fewer number of protective bands 75 may be used depending on the desired function of the coupler 1. In an embodiment, the exterior side 73 of the first sleeve 10 is generally cylindrical; wherein the diameter at the first end is the same as the diameter of the second end of the first sleeve 10. The protective bands 75 may have a generally flat side 80 for greater protection of the first sleeve 10 by covering more surface area of the first sleeve 10. Preferably, the protective bands 75 are also made of a durable rubber or plastic material.

In an embodiment, the bumpers 67 and/or the protective bands 75 may be replaced. More specifically, if the bumpers 67 and/or bands 75 become damaged or worn, a user may simply replace the bumpers 67 and/or bands 75 with new bumpers 66 and/or bands 75 to prolong the life of the coupler 1. In an embodiment, the diameter of all the bands 75 may be the same whereas the diameters of the bumpers 67 may each be unique. In an embodiment, the width of the bands 75 is greater than the widths of the bumpers. In an embodiment, the bands 75 may have a flat exterior side while the bumpers 67 may have a generally rounded edge similar to an o-ring.

Although embodiments of the invention are shown and described therein, it should be understood that various changes and modifications to the presently preferred embodiments will be apparent to those skilled in the art. Such changes and modifications may be made without departing from the spirit and scope of the invention and without diminishing its attendant advantages.

We claim:

1) A coupler comprising:
a main body having a hollow interior channel;
a first movable sleeve surrounding the main body; and
wherein the first movable sleeve has at least one bumper located around an exterior side of the first movable sleeve.

2) The coupler of claim 1 wherein the main body and the first movable sleeve are made of a durable and non-corrosive metal.

3) The coupler of claim 1 wherein the first movable sleeve has a first end and a second end and wherein a diameter at the first end of the first movable sleeve is less than a diameter at the second end of the first movable sleeve.

4) The coupler of claim 1 wherein the bumper is made of rubber or plastic.

5) The coupler of claim 1 further comprising:
at least one groove located on the exterior side of the first movable sleeve wherein the groove receives the bumper and wherein the bumpers are replaceable.

5) The coupler of claim 1 further comprising:
a second movable sleeve surrounding the main body.

6) The coupler of claim 5 further comprising:
a diameter at a first end of the second movable sleeve and a diameter at a second end of the second movable sleeve wherein the diameter at the first end and the diameter at the second end of the second movable sleeve are identical.

7) The coupler of claim 5 wherein the second movable sleeve has a groove which receives a removable band.

8) The coupler of claim 7 wherein the band is made of rubber or plastic.

9) The coupler of claim 7 wherein the bands have a flat exterior surface.
